(19) United States
(12) Patent Application Publication
(10) Pub. No.: US 2018/0032718 A1
(43) Pub. Date: Feb. 1, 2018

(54) ADVANCED PROTECTION SYSTEM FOR CONSUMABLE OR DETACHABLE PARTS FOR AN INDUSTRIAL PRINTER

(71) Applicant: Dover Europe Sàrl, Vernier (CH)

(72) Inventors: Patrick Soto, Saint Marcel-Les-Valence (FR); Damien Bonneton, Hostun (FR); Olivier Savry, Sassenage (FR)

(21) Appl. No.: 15/656,613

(22) Filed: Jul. 21, 2017

(30) Foreign Application Priority Data
Jul. 29, 2016 (FR) 16 57421

(51) Int. Cl. G06F 21/44; B41J 29/393; H04L 9/32; B41J 2/01; G06F 21/60; H04L 9/08

(52) U.S. Cl. CPC G06F 21/44; G06F 21/606; H04L 9/0819; H04L 9/3268; B41J 2/01; B41J 29/393

(57) ABSTRACT

A method for an industrial printer to secure at least one consumable or detachable element, the printer comprising a 1^{st} microcontroller that will make a data transfer with a 2^{nd} microcontroller of the printer or the consumable or detachable element, this method including at least: an authentication of the 2^{nd} microcontroller by the 1^{st} microcontroller, one of the microcontrollers sends at least one secret key Sk for data transfers between the two microcontrollers, to the other microcontroller, data exchange between the two microcontrollers by symmetric encryption using the first data transfer secret key Sk1.

### TECHNICAL DOMAIN AND PRIOR ART

This document relates to the domain of industrial printers, for example “Continuous Ink Jet” (CIJ) printers, “Drop On Demand” (DOD) printers for example of the “valve jet” type, heat transfer printers, laser printers, hot-melt ink jet printers, or printers of the “print and apply” type (printing on a support and then applying the printed support on a product). A printer is qualified as “industrial” in contrast to an office type printer that prints on sheets of paper or cardboard. Industrial printers are used particular to directly or indirectly make marking or coding type printouts, on products requiring traceability.

It also relates to a device and a method for securing the use of such a printer and/or for the use of spare parts, for example filters or pumps or consumables, for example ink or solvent cartridges used in such a printer.

Continuous ink jet (CIJ) printers are well known in the field of industrial coding and marking of various products, for example for marking barcodes, the expiration date on food products or references or distance marks on cables or pipes at high speed directly on the production system. This type of printer is also used in some decoration fields in which the possibilities of graphic printing of the technology are used.

These printers have several typical sub-assemblies as shown on FIG. 1.

Firstly, a print head 1, usually at a distance from the body of the printer 3, is connected to the printer by a flexible umbilical 2 containing all hydraulic and electrical connections necessary for operation of the head giving it flexibility that facilitates integration on the production line.

The body of the printer 3 (also called the desk or cabinet) normally contains three sub-assemblies:
a print circuit in the lower part of the console (zone 4′), that firstly supplies ink to the head at a stable pressure and of a suitable quality, and secondly to handle ink from the jets not used for printing,
a controller located in the top of the console (zone 5′), capable of managing action sequences and performing processing to activate the different functions of the ink circuit and the head. The controller can for example include a microcomputer or a microprocessor and/or one (or several) electronic boards and/or at least one onboard software, the programming of which controls the ink circuit and the print head 1. This controller transmits print instructions to the print head 1 and also controls the motors and valves of the system to manage the supply of ink and/or solvent to the circuit and to recover the mix of ink and air from the head. This is why programming is done for:
an interface 6 that provides the operator with means that he can use to control the printer and be informed about its operating state.

In other words, the cabinet comprises 2 sub-assemblies: in the upper part the electronics, the electrical power supply and the operator interface, and in the lower part an ink circuit supplying ink under pressure with nominal quality to the head, and recovery of ink not used by the head at negative pressure.

FIG. 2 diagrammatically shows a print head 1 of a CIJ printer. It comprises a drop generator 60 supplied with electrically conducting ink pressurised by the ink circuit.

This generator is capable of emitting at least one continuous jet through a small orifice called a nozzle. The jet is transformed into a regular sequence of identically sized drops under the action of a periodic stimulation system (not shown) upstream from the exit from the nozzle. When the drops 7 will not be used for printing, they are directed towards a gutter 62 that recovers them so as to recycle unused ink and return it to the ink circuit.

When ordered, devices 61 placed along the jet (charge and deflection electrodes) electrically charge the drops and deflect them in an electric field Ed. They are then deviated from their natural trajectory of ejection from the drop generator. The drops 9 intended for printing escape from the gutter and will be deposited on the support to be printed 8.

This description can be applied to continuous ink jet (CIJ) printers called binary or multi-deflected continuous jet printers. Binary CIJ printers are fitted with a head for which the ink generator has a multitude of jets, and each drop of a jet can only be oriented towards one of 2 trajectories: print or recovery. In multi-deflected continuous jet printers, each drop of a single jet (or several spaced jets) may be deflected on several trajectories corresponding to different charge orders from one drop to the next, thus scanning the zone to be printed along a direction that is the deflection direction, the other scanning direction of the zone to be printed is covered by relative displacement of the print head and the support to be printed 8. In general, the elements are arranged such that these 2 directions are approximately perpendicular.

An ink circuit of a continuous ink jet printer can firstly provides ink under regulated pressure and possibly solvent, to the drop generator of the head 1, and secondly creates a vacuum to recover fluids not used for printing and that are then returned from the head.

It can also be used for management of consumables (distribution of ink and solvent from a tank) and for checking and maintaining the ink quality (viscosity/concentration).

Finally, other functions are related to the comfort of the user and automatic control of some maintenance operations so as to guarantee constant operation regardless of usage conditions. These functions include rinsing the head with solvent (drop generator, nozzle, gutter) through preventive maintenance, for example replacement of limited life components, particularly filters and/or pumps.

These different functions have very different end purposes and technical requirements. They are activated and sequenced by the printer controller that will be increasingly complex when the number and the sophistication of functions increases.

Consumables are essentially in the form of cartridges or bottles containing ink or solvent adapted to operation of the machine.

There are various means of identifying such a cartridge or bottle.

Solutions are known based on identification means, for example as described in U.S. Pat. No. 6,738,903, but they cannot be used for authentication and to prevent cloning or emulation of the tag used particularly in some applications not connected to the network.

Another solution is known as disclosed in document WO 97/28001.

But these solutions do not solve the problem of being able to guarantee the authentic nature of the installed consumable to be able to guarantee the behaviour of the printer and the printing performances (quality, resistance, etc.), security of user data and safety regarding the use of printer chemicals.

This problem can be extended to the authentication of spare parts and more generally to detachable elements of printers or software that the printer can use and/or operating modes that the printer can apply.

Another problem is to be able to configure an industrial printer in various ways, without modifying the printer itself. Different configurations with different usage modes can be made necessary by different technical needs. This can result particularly in the need to make use of separate microcontrollers firstly to control functions related to printing, and secondly to authenticate and identify consumable or detachable elements.

These problems arise particularly in a context in which printers are not usually connected to a communication network.

Furthermore, when the printer will communicate with one or several consumable and/or detachable elements through several data transmission elements such as microcontrollers, at the present time there is no solution that guarantees the security of this entire chain of data transmission elements.

### PRESENTATION OF THE INVENTION

Thus there is a need to propose a solution adapted for an industrial printer designed to authenticate at least one consumable or detachable element, particularly to secure data transmissions between at least one 1^{st} printer microcontroller, and a 2^{nd} printer microcontroller that will communicate with the consumable or detachable element or that forms an integral part of this consumable or detachable element.

To achieve this, one embodiment discloses particularly a method for an industrial printer to authenticate or secure at least one consumable or detachable element, the printer comprising a 1^{st} microcontroller that will make a data transfer with a 2^{nd} microcontroller of the printer or the consumable or detachable element, this method including at least:

a) an authentication of the 2^{nd} microcontroller by the 1^{st} microcontroller, then

b) one of the microcontrollers sends at least one data transfer secret key Sk1 to the other microcontroller, for transfers between the two microcontrollers, then

c) a data exchange between the two microcontrollers by symmetric encryption using the first data transfer secret key Sk1.

The method includes at least one authentication phase of the 2^{nd} microcontroller by the 1^{st} microcontroller, before any data are exchanged between the two microcontrollers, by symmetric encryption. Thus, when the 2^{nd} microcontroller forms part of the printer and is separated from the 1^{st} microcontroller and the consumable or detachable element, this 2^{nd} microcontroller that will handle communications with the consumable or detachable element is authenticated which enables sending and receiving information by the 1^{st} microcontroller through this 2^{nd} microcontroller. When the 2^{nd} microcontroller forms part of the consumable or detachable element, this process can be used not only for identification of the consumable or detachable element, but also for authentication of this element.

Thus, this method secures data transmissions between the 1^{st} and 2^{nd} microcontrollers.

The fact that the data exchange step c) between the two microcontrollers is done by symmetric encryption reduces the resources necessary for securing data transfers between the two microcontrollers, which is possible without reducing security due to the authentication already made in step a).

The use of 2 distinct microcontrollers by the printer makes it possible to create a distinction between elements of the printer implementing the different printer functions, so that the microcontroller managing the control of print functions can be distinguished from the microcontroller forming the communication interface with the consumable or detachable elements.

Furthermore, transmission of the secret key for data transfers between the two microcontrollers made after authentication of the second microcontroller avoids the need to store this secret key in the second microcontroller that communicates with the consumable or detachable element. This transmission of the secret key applied after authentication improves the security of exchanges.

Such a method is used by an industrial printer and not an office automation printer because firstly the cost of such a method would be inappropriate for an office printer, and secondly because an office printer is not intended to work independently and is connected to a computer.

Step a) may comprises at least the following steps:
send an electronic certificate C and a public key Pk2 generated from said electronic certificate C, from the 2^{nd} microcontroller to the 1^{st} microcontroller,
use the public key Pk2 to decrypt a signature contained in the electronic certificate C and encrypted by a private key Sk2 memorised in the 2^{nd} microcontroller,
generate a first random data N₀ by the 1^{st} microcontroller and send the first random data N₀ to the 2^{nd} microcontroller,
the 2^{nd} microcontroller encrypts the first random data N₀ using the private key Sk2 memorised in the 2^{nd} microcontroller, and the first encrypted random data N₂ is sent to the 1^{st} microcontroller,
the 1^{st} microcontroller decrypts the first encrypted random data N₂ using the public key Pk2, and the decrypted data N₂⁰ is compared with the first random data N₀ generated by the 1^{st} microcontroller.

In this case, authentication of the 2^{nd} microcontroller by the 1^{st} microcontroller uses an asymmetric encryption guaranteeing good security for this authentication.

When the 2^{nd} microcontroller is separated from the consumable or detachable element, step c) may include sending a secret authentication key K_AUTH from the 1^{st} microcontroller to the 2^{nd} microcontroller, between the 2^{nd} microcontroller and the consumable or detachable element. This secret authentication key between the 2^{nd} microcontroller and the consumable or detachable element originates from the 1^{st} microcontroller. This avoids the need to store this secret authentication key permanently in the 2^{nd} microcontroller, thus reducing security constraints on this 2^{nd} microcontroller that can be simpler than the 1^{st} microcontroller. The transfer of this secret authentication K_AUTH key from the 1^{st} microcontroller to the 2^{nd} microcontroller can be done encrypted using a symmetric encryption, for example the 1^{st} data transfer secret key Sk1.

Other data transfer secret keys may be transmitted between the two microcontrollers encrypted using the 1^{st} secret key, for example keys used for MAC type code calculations to authenticate exchanged data.

The method may also include mutual authentication of the 2^{nd} microcontroller and the consumable or detachable element using the secret authentication key K_AUTH. The security of exchanges between the 2^{nd} microcontroller and the consumable or detachable element is thus improved firstly because the authentication made is mutual, and secondly because the secret authentication key used by the 2^{nd} microcontroller comes from the 1^{st} microcontroller. This mutual authentication may be made using message authentication codes (MAC codes) calculated from random numbers and the secret authentication key K_AUTH previously transferred to the 2^{nd} microcontroller by the 1^{st} microcontroller.

Apart from its use for authentication between the 2^{nd} microcontroller and the consumable or detachable element, the secret authentication key K_AUTH can be used to make one or several data transfers between the 2^{nd} microcontroller and the consumable or detachable element, particularly for symmetric encryption of data exchanged between the 2^{nd} microcontroller and the consumable or detachable element. As a variant, in order to improve the security of exchanges, a 2^{nd} data transfer secret key K_TRF, distinct from the secret authentication key K_AUTH, may be exchanged between the 2^{nd} microcontroller and the consumable or detachable element (for example provided by the consumable or detachable element after mutual authentication with the 2^{nd} microcontroller) and used to encrypt data exchanges between the 2^{nd} microcontroller and the consumable or detachable element.

The method may also include a firmware authentication step of at least one of the microcontrollers, before step a). This authentication can be made through the use of a electronic certificate of the microcontroller.

The method may also include:
the 1^{st} microcontroller sends a write request and/or a read request to the 2^{nd} microcontroller, in a circuit of the consumable or detachable element;
an authentication by the 2^{nd} microcontroller, of data to be written sent by the 1^{st} microcontroller, and/or an authentication by the 1^{st} microcontroller of read data sent by the 2^{nd} microcontroller.

The printer may also comprise emitter/receiver (that is able to emit and receive) for, or means for making, data exchanges with the consumable or detachable element, the authentication method also comprising an authentication of data exchange means by the 2^{nd} microcontroller.

In such a method, means, or emitter/receiver, of data exchange with the printer may be of the RFID or wire type, the consumable or detachable element also comprising RFID or wire type data exchange means or emitter/receiver.

The consumable or detachable element may for example be an ink or solvent cartridge, or a filter or a pump or a solenoid valve or a removable module, for example a printer ink circuit or printer print head, or a data support, or a computer code.

The printer may be a CIJ or DoD type printer or a thermal ink jet printer, or a heat transfer printer, a laser printer or a hot-melt ink jet printer.

Another embodiment concerns a device for control of an industrial printer capable of checking the authenticity of at least one consumable or detachable element, comprising a 1^{st} microcontroller and a 2^{nd} microcontroller programmed to implement an authentication method as described above.

It is also proposed an industrial printer comprising such a control device.

Another embodiment concerns a consumable or detachable element of an industrial printer, comprising means of implementing an authentication method like that described above.

Another embodiment relates particularly to a consumable or detachable element of an industrial printer, comprising means of implementing an authentication method in which a mutual authentication between a microcontroller of the industrial printer and the consumable or detachable element is made using a secret authentication key K_AUTH memorised both in the microcontroller and in the consumable our detachable element, in other words that is not exchanged between the microcontroller and the consumable or detachable element before he mutual authentication is made.

Another embodiment also relates to a consumable or detachable element of an industrial printer, comprising:
RFID type emitter/receiver,
means of sending data to an RFID reader of said printer, authenticated by said printer or to a microcontroller of said printer and authenticated by it, so as to authenticate the consumable or detachable element.

The element may comprise means of receiving data from the RFID reader of said printer, authenticated by said printer or a microcontroller of said printer authenticated by the printer, so as to authenticate the RFID reader or the microcontroller of said printer.

Finally, such an element may comprise means of receiving a second data transfer secret key K_TRF with the RFID reader or the microcontroller of said printer.

### BRIEF DESCRIPTION OF THE FIGURES

FIG. 1 represents a known printer structure,

FIG. 2 represents a known structure of a print head of a CIJ type printer,

FIG. 3 diagrammatically represents a control device structure of an industrial printer according to one embodiment,

FIG. 4 represents the steps in an authentication method between 2 microcontrollers, according to one embodiment,

FIGS. 5A and 5B represent steps in an authentication of write and read requests according to one embodiment,

FIG. 6 represents the manufacturing details of a structure of a control device and a tag of a consumable or detachable element, according to one embodiment,

FIGS. 7A and 7B represent steps in authentication of a consumable or detachable element and of a controller according to one embodiment,

### DETAILED PRESENTATION OF ONE EMBODIMENT

In the following description, the term “consumable element” is used to refer to an element that will be renewed due to the reduction of its content or its consumption in order to perform a function of the printer. It may also be an element for which an authorisation for use is given for a limited period in time, for example a software function.

A detachable element is an element that must be temporarily connected to the printer, for example such as a filter, a pump, a solenoid valve, a removable element that may for example form part of the ink circuit of the printer or the print head, or a data support, to implement a function of the printer.

The example of an ink cartridge is often referred to below; the cartridge can be connected to the printer to supply ink to it. The cartridge is both consumable and detachable. But the invention is also applicable to a spare part, for example a filter, or a pump, or a solenoid valve, or any other module or sub-assembly of the printer, for example a removable module like that described in document WO 2014/154830. Each of these elements has a limited life, and at the end of this life it has to be replaced to assure good operation of the printer.

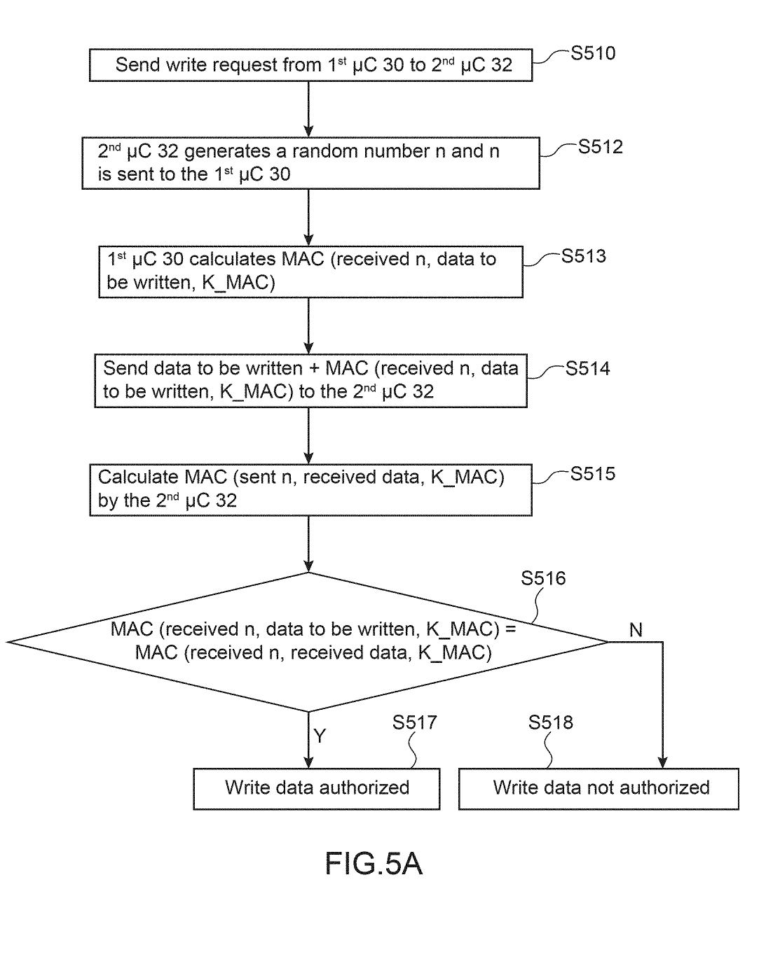

FIG. 3 very diagrammatically shows the controller 3 of a printer that, according to the invention, may comprise a 1^{st} microprocessor, preferably in the form of a microcontroller 30, and a 2^{nd} microprocessor, preferably in the form of a microcontroller 32. The following describes an embodiment with 2 microcontrollers but can be transposed to an embodiment with 2 microprocessors (or 1 microprocessor and 1 microcontroller), with adapted peripheral elements (the microprocessor(s) being provided with at least one memory and means of communication with at least one other printer circuit, in particular with the other microprocessor or microcontroller). Each microcontroller comprises a processor, one or several memory zones, at least one input-output interface, and data encryption—decryption means.

Preferably, the size of the different key encryption—decryption keys described above are equal to at least about 1024 bits for asymmetric algorithms, and equal to at least about 128 bits for symmetric algorithms.

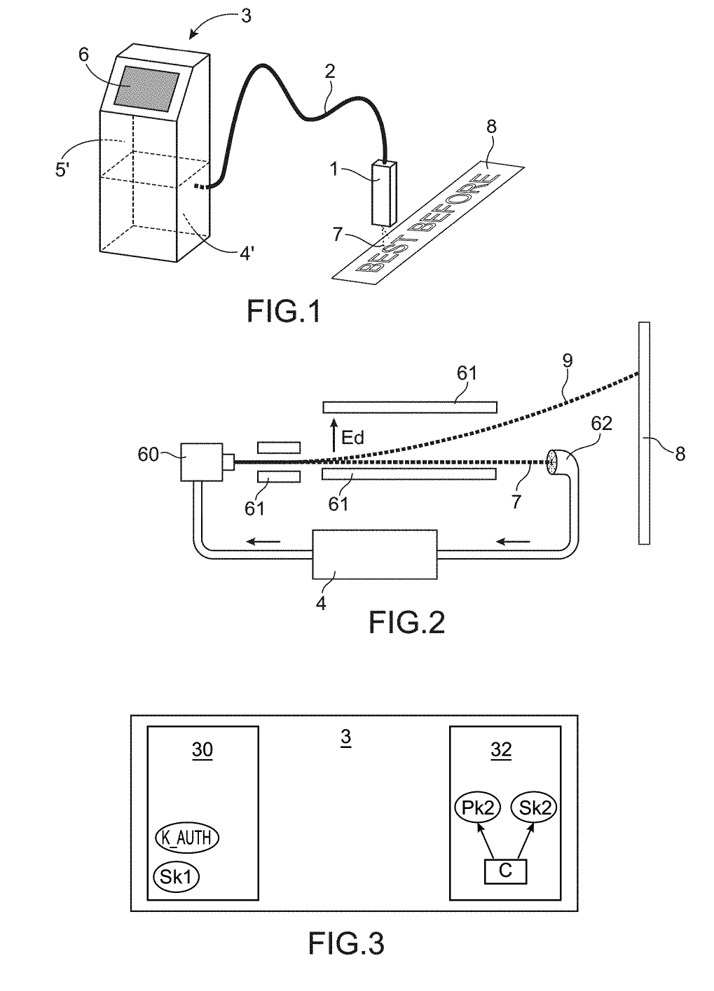

The 1^{st} microcontroller 30 is programmed particularly to control printing operations of the printer, and for management of fluids (ink and solvent) that supply the main reservoir and/or a print head 1 in the case of a CIJ printer (FIG. 1).

The 2^{nd} microcontroller 32 will enable information exchange with at least one spare part, in other words a detachable element or a consumable element.

The 1^{st} microcontroller 30 memorises a secret key Sk1, stored during manufacturing or preparation of the 1^{st} microcontroller 30. The 1^{st} microcontroller 30 also memorises a secret authentication key K_AUTH that, after authentication of the 2^{nd} microcontroller 32 by the 1^{st} microcontroller 30, will be used to make an authentication between a consumable or detachable element and the 2^{nd} microcontroller 32.

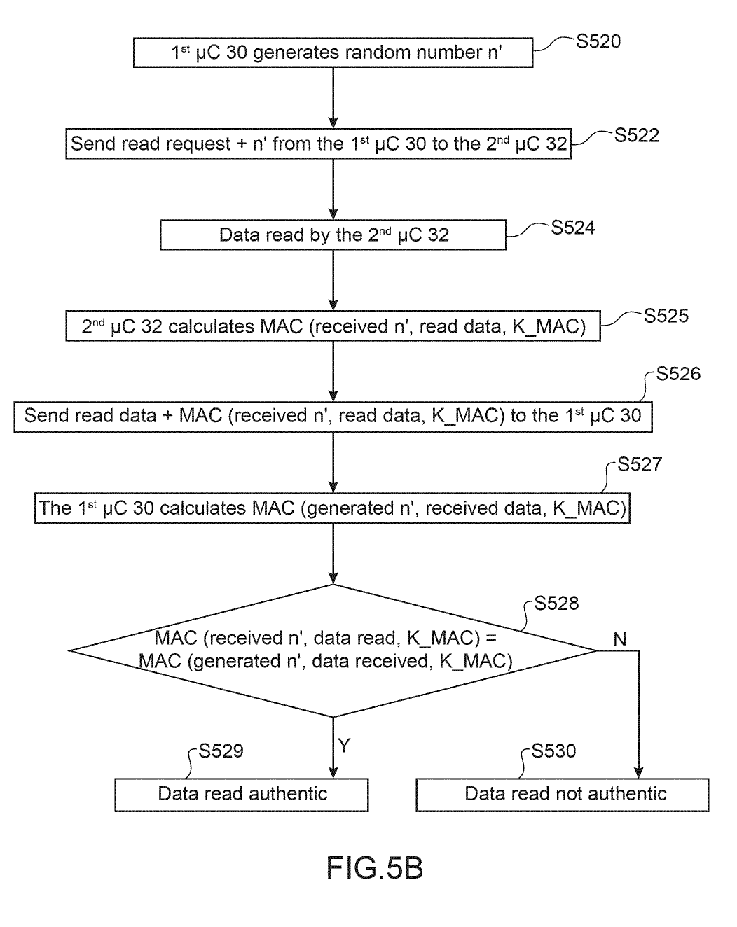

Before the secret key Sk1 is transferred from the 1^{st} microcontroller 30 to the 2^{nd} microcontroller 32, an authentication of the 2^{nd} microcontroller 32 is made by the 1^{st} microcontroller 30. The steps used for this authentication are represented in FIG. 4.

The 2^{nd} microcontroller 32 memorises an electronic certificate C, and a secret key Sk2 and a public key Pk2 generated from the electronic certificate C.

The electronic certificate C and the public key Pk2 of the 2^{nd} microcontroller 32 are transmitted by the 2^{nd} microcontroller 32 to the 1^{st} microcontroller 30 (step S 302), that can thus check the authenticity of the electronic certificate C (step S 303).

The verification of the authenticity of the electronic certificate C made during step S 303 may for example correspond to a verification of a signature included in the electronic certificate C. When this electronic certificate C is produced, this signature is encrypted with the secret key Sk2. In decrypting this signature using the public key Pk2, the 1^{st} microcontroller 30 can thus compare the encrypted signature obtained with that expected and make sure that the 2^{nd} microcontroller 32 actually corresponds to that with which it is supposed to exchange data.

If the authenticity of the electronic signature C is not confirmed, the process stops and the data exchange between the two microcontrollers 30, 32 is not authorised (S 304).

If the authenticity of the electronic certificate C is confirmed, a verification is made of the authenticity of the public key Pk2 that was used to verify the authenticity of the electronic certificate C, to confirm the authenticity of the 2nd microcontroller 32. To achieve this, the 1^{st} microcontroller 30 can generate a random number N₀ (S 306), that is sent to the 2^{nd} microcontroller 32, that will encrypt it with its secret key (S 308). The encrypted number N₂ thus obtained is then transmitted to the 1^{st} microcontroller 30 (S 310), that decrypts it with the public key Pk2 previously transmitted by the 2^{th} microcontroller 32 and compares the result N₂⁰ of the decryption with the random number N₀ generated initially (S 312).

If the 2 numbers N₀ and N₂⁰ above are not equal (or more generally, if a relation between them is not satisfied), the 1^{st} microcontroller 30 does not identify the 2^{nd} microcontroller 32 as being authentic, and no data can be exchanged between the two (S 304).

If these 2 numbers are equal (or more generally, if a relation between the two is satisfied such that it can be concluded that they agree or correspond), then the 1^{st} microcontroller 30 identifies the 2^{nd} microcontroller 32 as being authentic. Data, for example the secret key Sk1, can be exchanged between the 2 microcontrollers 30, 32 (S 314).

To secure the transfer of the secret key Sk1 from the 1^{st} microcontroller 30 to the 2^{nd} microcontroller 32, the secret key Sk1 can be encrypted with the public key Pk2 that is available to the 1^{st} microcontroller 30. The 2^{nd} microcontroller 32 then decrypts it with the secret key Sk2.

A secret key K_MAC, different from the previous keys, can then be generated by one of the microcontrollers 30 32 and sent to the other microcontroller, for example encrypted with the key Sk1. This key K_MAC may for example be sent from the 2^{nd} microcontroller 32 to the 1^{st} microcontroller 30. The microcontroller that receives this key decrypts it using its own key Sk1. This key K_MAC will subsequently be used for exchanges between the two microcontrollers. The values of secret keys Sk1 and K_MAC can change regularly, for example each time that the microcontroller that generates them starts, thus improving security for the transfer of data between the two microcontrollers 30, 32. In the example described herein, only the secret authentication key K_AUTH has a value that does not change and is stored in the first microcontroller 30 when it is being programmed.

Finally, when the 2^{nd} microcontroller 32 forms part of the printer and authentication of a consumable or detachable element is intended to be done by the 2^{nd} microcontroller 32, the secret authentication key that is different from the previous keys, and is sent from the 1^{st} microcontroller 30 to the 2^{nd} microcontroller 32, encrypted by the key Sk1. This key K_AUTH will subsequently be used for the authentication between the 2^{nd} microcontroller and a consumable or detachable element (or a circuit associated with this consumable or detachable element) in which this secret authentication key K_AUTH is also stored. For security reasons, this secret key K_AUTH is not stored in the firmware of the 2^{nd} microcontroller 32. Transmitting this key from the 1^{st} microcontroller 30 to the 2^{nd} microcontroller 32 makes it possible to memorise this key in a secure memory (not legible from outside) or temporarily in the RAM of the 2^{nd} microcontroller 32. This key K_AUTH can be considered as being a “Master Key”, the consumable or detachable elements having keys that can be derived from this master key to improve the security of exchanges with these elements.

All communications between the 2 microcontrollers can then be made using a symmetric encryption algorithm and the key K_MAC, particularly to exchange technical usage data (they will apply to technical aspects or functions of the machine and/or technical operating aspects of the machine) and/or read and/or write requests, for example in a circuit associated with a consumable or detachable element.

When the 2^{nd} microcontroller 32 is itself part of a detached part or a consumable element, a secure data exchange between the 1^{st} microcontroller 30 and this detached part or this element is thus assured due to the authentication of the 2^{nd} microcontroller 32 described above.

Furthermore, the authentication described above by the microcontrollers 30, 32 may be mutual, in other words the 2^{nd} microcontroller 32 can make sure that the 1^{st} microcontroller 30 is authentic, and the 1^{st} microcontroller 30 can make sure that the 2^{nd} microcontroller 32 is authentic.

The firmware of these microcontrollers 30, 32 can be verified in one or both of the microcontrollers 30, 32 before these authentication operations, making use of an electronic certificate present in each of the microcontrollers 30, 32, using a “hash” function. For the 2^{nd} microcontroller 32, the electronic certificate used for this verification is distinct from that previously used for authentication of the 2^{nd} microcontroller 32.

A signature is stored in the memory of one of the microcontrollers 30, 32 to verify to the firmware of this microcontroller. This signature is calculated when the microcontroller is manufactured by applying a hash function to the authentic firmware of the microcontroller, and then encrypting the hash value obtained using a secret key generated from the certificate and stored in the microcontroller. When the microcontroller starts, a hash function similar to that used during manufacturing of the microcontroller is applied to the firmware to be verified that is present in the microcontroller memory. At the same time, the encrypted hash value also present in the microcontroller memory is decrypted using a public key generated by the certificate stored in the microcontroller. The decrypted hash value and the hash value obtained from the firmware present in the microcontroller memory are then compared to determine whether or not the firmware present in the microcontroller memory is authentic.

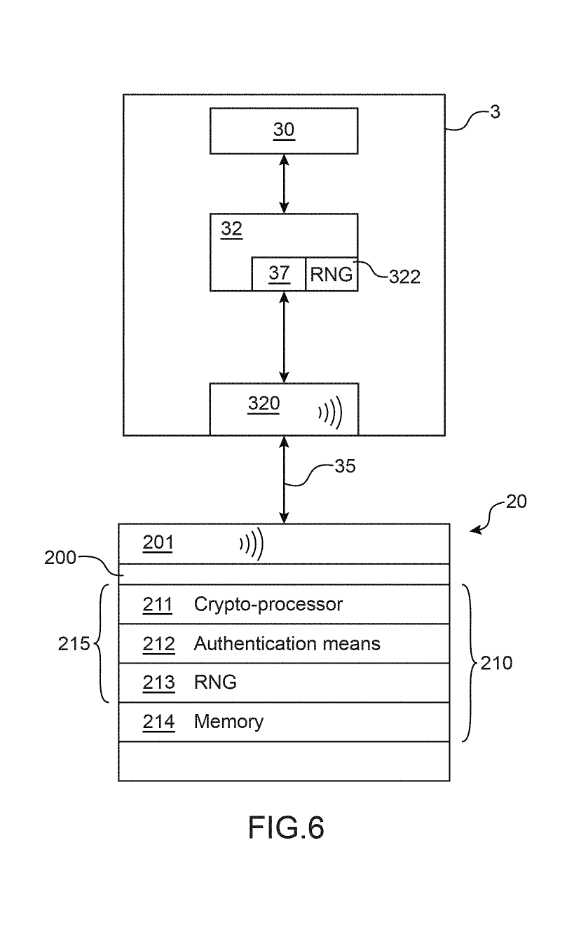

FIGS. 5A and 5B represent a write request and a read request respectively, for example in a circuit associated with a consumable or detachable element. This request is addressed by the 1^{st} microcontroller 30 to the 2^{nd} microcontroller 32.

More precisely, a write request might comprise (FIG. 5A):
send a write request from the 1^{st} microcontroller 30 to the 2^{nd} microcontroller 32 (S 510);
the 2^{nd} microcontroller 32 generates a random number n that is then sent to the 1^{st} microcontroller 30 (S 512);
the 1^{st} microcontroller 30 calculates a Message Authentication Code (MAC) from the data to be written, the received random number n and the secret key K_MAC available to the 1^{st} microcontroller 30 (S 513). For example, such a MAC is calculated using a CBC-MAC type algorithm using the random number n as initialisation vector.
send the data to be written (possibly encrypted for example using the secret key Sk1), and the MAC calculated using the 2^{nd} microcontroller 32 (S 514);
the 2^{nd} microcontroller 32 calculates a MAC from the received data to be written, the generated random number n and the secret key K_MAC available to the 2^{nd} microcontroller 32 (S 515).
the 2^{nd} microcontroller 32 compares the MAC sent by the 1^{st} microcontroller 30 with the MAC generated by the 2^{nd} microcontroller 32 (S 516);
if the two MACs compared by the 2^{nd} microcontroller 32 are identical, then the 2^{nd} microcontroller 32 can consider that the received data are authentic and can write the data (after decrypting them if these data had been encrypted) in a circuit associated with the consumable or detachable element (S 517). Otherwise, writing these data is not authorised (S 518).

In addition to this data verification made by the 2^{nd} microcontroller 32, the 2^{nd} microcontroller 32 can generate an acknowledgement of reception and another MAC calculated from the data in the acknowledgement of reception, the generated random number n and the secret key K_MAC available to the 2^{nd} microcontroller 32, and send it to the 1^{st} microcontroller 30. The 1^{st} microcontroller 30 can make a verification similar to that described above, in which by the 1^{st} microcontroller 30 uses data from the received acknowledgement of reception, the received random number n and the secret key K_MAC available to the 1^{st} microcontroller 30, to generate another MAC, and the 1^{st} microcontroller 30 compares these two MACs.

The use of MACs during exchanges of data to be written and the acknowledgement of reception makes it possible to implement an “anti-replay” function making data exchanges between the two microcontrollers 30, 32 secure because the sent MACS are different every time due to the random numbers used.

A read request may comprise (FIG. 5B):
the 1^{st} microcontroller 30 generates a random number n′ (S 520);
the 1^{st} microcontroller 30 sends a read request and the random number n′ to the 2^{nd} microcontroller 32 (S 522);
the 2^{nd} microcontroller 32 reads data, for example in a circuit associated with the consumable or detachable element and using appropriate read means (S 524);
the 2^{nd} microcontroller 32 calculates a MAC from the read data, the received random number n′ and the secret key K_MAC available to the 2^{nd} microcontroller 32 (S 525);
the read data (encrypted or not) and the calculated MAC are sent from the 2^{nd} microcontroller 32 to the 1^{st} microcontroller 30 (S 526);
the 1^{st} microcontroller 30 calculates a MAC from the received read data, the generated random number n′ and the secret key K_MAC available to the 1^{st} microcontroller 30 (S 527);
the 1^{st} microcontroller 30 compares the MAC generated by the 1^{st} microcontroller 30 with the MAC sent by the 2^{nd} microcontroller 32 (S 528);
if the two MACs compared by the 1^{st} microcontroller 30 are identical, then the 1^{st} microcontroller 30 can consider the read data to be authentic (S 529). Otherwise, the data read are not considered to be authentic (S 530).

In addition to this data verification made by the 1^{st} microcontroller 30, the 1^{st} microcontroller 30 can generate an acknowledgement of reception and another MAC calculated from the data in the acknowledgement of reception, the generated random number n′ and the secret key K_MAC available to the 1^{st} microcontroller 30, and send it to the 2^{nd} microcontroller 32. The 2^{nd} microcontroller 32 can make a verification similar to that described above, in which by the 2^{nd} microcontroller 32 uses data from the received acknowledgement of reception, the received random number n′ and the secret key K_MAC available to the 2^{nd} microcontroller to generate another MAC 32, and the 2^{nd} microcontroller 32 compares these two MACs.

The 2^{nd} microcontroller 32 can be equipped with communication means 320, for example of the RFID type (they are then called an “RFID reader”), and are used in a dialogue with consumables or spare parts. They can be separated from the microcontroller 32, in which case the exchanges with a circuit (or “tag”) of a consumable or detachable element will take place between this element and the RFID reader 320. In the case, the reader 320 is equipped with a circuit, for example a microprocessor, that will be used for dialogue with the 2^{nd} microcontroller 32 and with the circuit of the consumable or detachable element, itself provided with RFID communication means.

As a variant, the communication between the 2^{nd} microcontroller 32 of the printer and the consumable or detachable element can be of the contact type. In this case, contacts are provided on each circuit of these elements for the transmission of data between these elements. According to another variant, this communication can be wired.

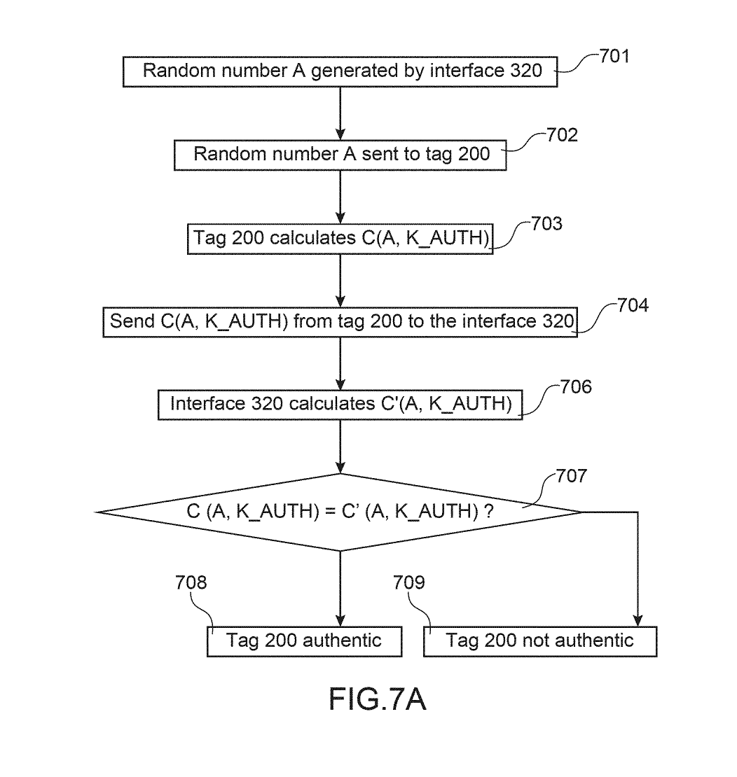

FIG. 6 very diagrammatically represents the printer controller 3 with its 2 microcontrollers 30, 32, as explained above, and a consumable or detachable element 20, for example a spare part or an ink or solvent cartridge.

As explained above, the 2^{nd} microcontroller 32 is in communication with, e.g. RFID type communication means 320 (or RFID interface) that will be used to dialogue with the consumable or detachable part 20. The consumable or detachable element 20 is equipped with a circuit 200 (subsequently called a “tag”) that will implement the steps described below. This tag 200 may for example be made in the form of a processor of a microprocessor, or an FPGA. For example, it may be applied in contact with a wall of the consumable or detachable element 20, so as to facilitate the dialogue (or data exchange) with the 2^{nd} microcontroller 32 through the means 320. As a variant, it is possible that the 2^{nd} microcontroller 32 corresponds to these means 320, or that these means 320 form part of the 2^{nd} microcontroller 32.

This tag 200 can be programmed to implement a method according to the invention. Communications means, or an interface, 201, for example of the RFID type, are also provided and will be used for dialogue with the means 320.

According to one example embodiment, the reference 210 denotes a tag circuit 200, for example made in the form of a microprocessor, or an FPGA, that is programmed to perform some functions or steps in the method according to the invention. For example, this circuit 210 is provided with authentication means globally denoted as reference 215 and that, with the secret key K_AUTH, will be used for mutual authentication between the consumable and the microcontroller 32. The authentication means 215 comprise means 213 of generating one or several items of information, for example random numbers, means 212 of implementing an authentication method and encryption means 211. This circuit may be provided with memorisation means 214 to memorise data, and particularly data to implement a method according to the invention, for example such as the secret authentication key K_AUTH or keys derived from it such as the data exchange secret key K_TRF.

This circuit 210 will supply data to be transmitted to the RFID interface 320, or to be made available to this interface (for example so that it can read these data), to the means 201, and/or it will receive data to be written by the means 320 through the means 320.

Reference 35 symbolises data exchanges between the controller 3 and the tag 200 of the consumable or detachable element 20. As mentioned above, this is an example with a data exchange by RFID mode.

In the 2 cases (exchange by RFID or by contact), an event will trigger a 1^{st} dialogue step, for the cases of an authentication or a data exchange. This is the case when a consumable or detachable element 20 has to be used, par example:
when the printer startup check is being made, the printer detecting the presence of the consumable or detachable element 20, this detection forming the above event,
or when the consumable or detachable element 20 is connected, causing detection by the controller 3 that will then trigger a method according to the invention,
or when the need for a consumable or detachable element becomes clear, for example when an ink level is detected in the main reservoir such that the ink cartridge has to be supplied.

FIG. 6 represents an example of this architecture is shown in somewhat more detail, in its version making use of RFID type communication means.

Reference 32 denotes the 2^{nd} microcontroller programmed to perform some functions or some steps in the method. For example, this circuit 32 is provided with means 322 to generate one or more items of information, for example random numbers. This circuit may be provided with memorisation means 37 to memorise data, and particularly data to implement a method according to the invention, for example such as data for different secret keys as explained above.

The 2^{nd} microcontroller 32 will provide data to be transmitted to the consumable or detachable element 20 (in fact to the circuit (described below) associated with the consumable or detachable element 20), to the means 320, and/or it receives data transmitted by the same consumable or detachable element 20 (in fact by the circuit (described below) associated with the consumable or detachable element 20), through the means 320.

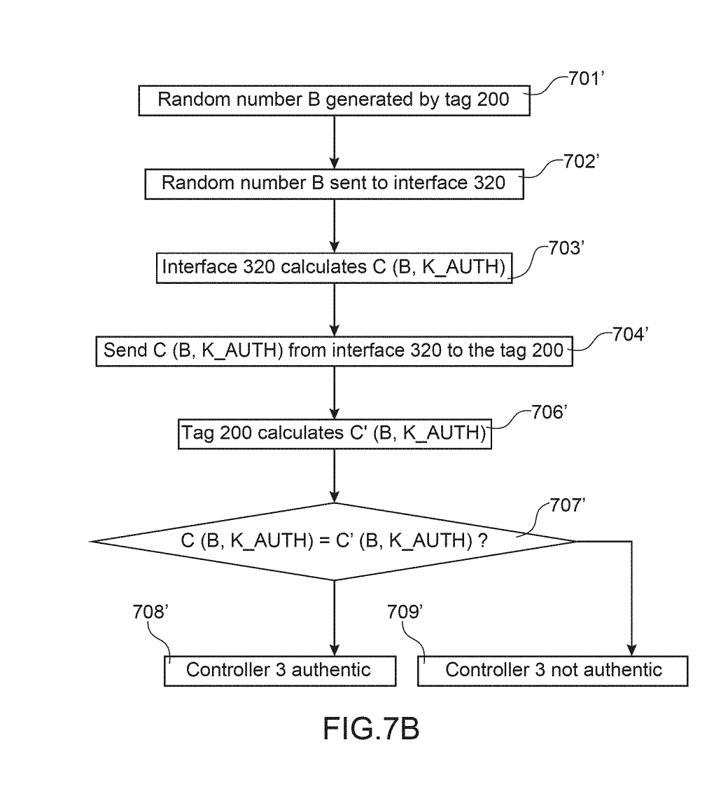

An example of a method that can be used by this system will be described with reference to FIG. 7A. This is an authentication algorithm or method used before data are exchanged, between the tag 200 and the RFID interface 320, or more generally between the tag 200 and the 2nd microcontroller 32. In the following description, the RFID interface 320 implements the different steps in this authentication.

According to this example, both the RFID interface 320 and the tag 200 of the consumable or detachable element 20 memorise and use a secret authentication key K_AUTH; an encryption algorithm uses this key, the data for this algorithm being memorised firstly in the RFID interface 320 and secondly in the tag 200.

When an event occurs, par example one of the events mentioned above, the means 320 generate a 1^{st} random number (more generally an information item) A (step 701), for example with 48 bits, that it sends (step 702) to the tag 200 of the consumable or detachable element 20; which encrypts this number (step 703) in the form of a MAC using its encryption algorithm and the K_AUTH key memorised in the tag 200 of the consumable or detachable element 20 and sends this encrypted number C(A, K_AUTH) that for example contains 64 bits to the printer (in step 704).

The RFID interface 320 performs the same operation—it encrypts this same random number A (step 706) using its encryption algorithm and the key K_AUTH memorised in the 2^{nd} microcontroller 32, thus forming the MAC C′(A, K_AUTH).

The RFID interface 320 compares the result C′(A, K_AUTH) obtained by its internal calculation with the result C(A, K_AUTH) returned by the tag 200 (step 707).

If C′(A, K_AUTH)=C(A, K_AUTH) (or more generally, if a relation between C(A, K_AUTH) and C′(A, K_AUTH) is satisfied that justifies that they are the same or that they correspond), then the tag (and the associated consumable) is authentic (step 708) and the data, for example confidential data contained in the tag 200, can be exchanged between this tag 200 and the RFID interface 320. These data can be qualified as technical usage data (they will apply to technical aspects or functionalities of the machine and/or technical operating aspects of the machine). Otherwise, tag 200 and the consumable or detachable element 20 with which is associated, is recognised as not being authentic (step 709), and these data cannot be exchanged between this tag and the RFID interface 320.

More generally, an authentication can be made as described above when the spare part is installed or before a consumable is drawn off (for example a fluid such as ink or a solvent) in a cartridge or a bottle.

When this authentication method is used, the K_AUTH key is used to calculate the MAC that will or will not authorise transmission of information from the “tag” 200 to the controller 3 (in fact to the RFID interface 320), and vice versa.

In order to provide better protection of data of the tag 200, the authentication can be mutual and the tag 200 can in turn generate a random number that it submits to the printer, using the method in FIG. 7B:
the tag 200 generates a random number (more generally an information item) B (step 701′), for example with 48 bits, that it sends (step 702′) to the RFID interface 320 that encrypts this number (step 703′) in the form of a MAC using its encryption algorithm and the secret key K_AUTH memorised in the 2^{nd} microcontroller 32 and sends this encrypted number C(A, K_AUTH) that for example contains 64 bits (in step 704′), to the tag 200
the tag 200 performs the same operation: it encrypts this same number B (step 706′) using its encryption algorithm and the secret key K_AUTH memorised in the tag 200, thus forming the MAC C′(B, K_AUTH),
the tag 200 compares the result C′(B, K_AUTH) obtained by its internal calculation with the result C(B, K_AUTH) returned by the RFID interface 320 (step 707′).

If C′(B, K_AUTH)=C(B, K_AUTH) (or more generally, if a relation between C(B, K_AUTH) and C′(B, K_AUTH) is satisfied such that it can be concluded that they agree or correspond), then the tag 200 can exchange data with the controller 3 (step 708′). Otherwise, the latter is deemed to be not authentic or, more generally, not authorised to exchange data with the controller 3 (step 709′). It would be possible to work in the reverse order: firstly, the method described above with reference to FIG. 7B and then the method described above with FIG. 7A.

In general, in the case of a mutual authentication, the 2 authentications will preferably be validated (by the controller 3 or by the consumable or detachable element 20 respectively) to conclude whether or not a data exchange can be made between the consumable or detachable element 20 and the printer and to authorise such an exchange, and subsequently to use the consumable or detachable element 20. Furthermore, in the case of a mutual authentication, the following steps could be used:
the means 320 generate a 1^{st} random number A that they send to the tag 200 of the consumable or detachable element 20;
the tag 200 of the consumable or detachable element 20 my generate a 2^{nd} random number B that it sends to the means 320;
the means 320 generate a MAC from the random numbers A and B and the secret key K_AUTH memorised in the 2^{nd} microcontroller 32, and send this MAC to the tag 200;
the tag 200 generates a MAC from the random numbers A and B and the secret key K_AUTH memorised in the tag 200, and compares this MAC with the MAC sent by the means 320. The tag 200 uses the result of this comparison to authenticate or not authenticate the means 320. The MAC generated by the tag 200 is also sent to the means 320;
the means 320 compare the generated MAC with the MAC sent by the tag 200. The means 320 use the result of this comparison to authenticate or not authenticate the tag 200.

The method described above guarantees the authentic aspect of the consumable and/or a spare part and the inviolability of data stored in this tag. Thus, this authentication of the consumable or detachable element guarantees that the identifier or any other information transmitted by this consumable or detachable element 20 is authentic.

The algorithm described above for authentication between the consumable or detachable element 20 and the printer controller 3 corresponds to one of several possible algorithms. There are other possible mutual authentication algorithms, for example using several random variables or functions.

Furthermore, the use of random numbers to generate MACs assures that MACs are renewed, thus increasing security within the system.

The algorithm or the method disclosed above can be used by the printer using its controller programmed for this purpose, and by the tag also programmed for this purpose.

An algorithm or method identical to or similar to that presented above can be used between the second microcontroller 32 and the RFID interface 320. In other words, the RFID interface 320 can be authenticated by the second microcontroller 32. And this authentication can be mutual, for example using the same scheme as is described above with reference to FIGS. 7A and 7B.

During a data exchange process between the printer (controller) and the tag 200, data can be sent from the printer (or the controller) to the tag 200, these data having been encrypted using the key K_AUTH, or using the shared key K_TRF. Data sent by the tag 200 to the controller 3 are read (decrypted) by the controller, also using the shared key. The shared key K_TRF is also used in the tag 200 to send data to the controller 3 or to read or write data sent by the controller 3.

According to one advantageous embodiment, the shared key, or the data transfer key, K_TRF, is not the same key as the secret authentication key K_AUTH. In this case, it is possible that this shared key K_TRF can be more easily decoded than the authentication key K_AUTH. The shared key K_TRF is used mainly, or uniquely, for encryption of information stored in the memory. The authentication K_AUTH is used mainly or uniquely for authentication of the consumable or detachable element by the printer controller or for mutual authentication or vice versa, of the consumable or detachable element and the controller. This can limit risks of pirating of data contained in the tag and in the associated consumable or detachable element.

For example the shared key K_TRF may be:
determined or chosen by the manufacturer of the controller 3, for example during fabrication of the controller; this shared key could possible vary in time, for example periodically, the controller then being able to have the list of keys and the algorithm that can be used to find the shared key to be used at any required instant;
provided by the consumable or detachable element to the controller, but only after authentication between them has been validated;
a key derived from the secret authentication key K_AUTH.

In the example embodiments described above, the identification and authentication are done for transmission of information in a chain of transmission elements formed of at least 3 elements: the 1^{st} microcontroller 30, the 2^{nd} microcontroller 32 and the consumable or detachable element 20.

As a variant, when the 2^{nd} microcontroller 32 forms part of the consumable or detachable element 20, this identification and authentication method can be used in a chain composed of 2 elements: the 1^{st} microcontroller 30 and the assembly formed from the 2^{nd} microcontroller 32 and the consumable or detachable element 20. In this case, the identification and authentication described above between the 2 microcontrollers makes the identification and authentication between the 1^{st} microcontroller 30 and the consumable or detachable element 20.

An ink circuit of an inkjet printer and its ink and solvent cartridges, when present, is described for example in document WO 2014/154830 or WO 2009/047510.

Remember that the inkjet circuit performs the following principal functions:
supply suitable quality ink under pressure to the drop generator of the head 1,
recover and recycle fluids not used for printing returned from the gutter of the head 1,
suction to drain the drop generator located in the head 1,
supply solvent to the head 1 for rinsing done during head maintenance operations.

Either or both of the cartridges in this circuit may be provided with a tag according to this invention. A printer controller may be of the type described above.

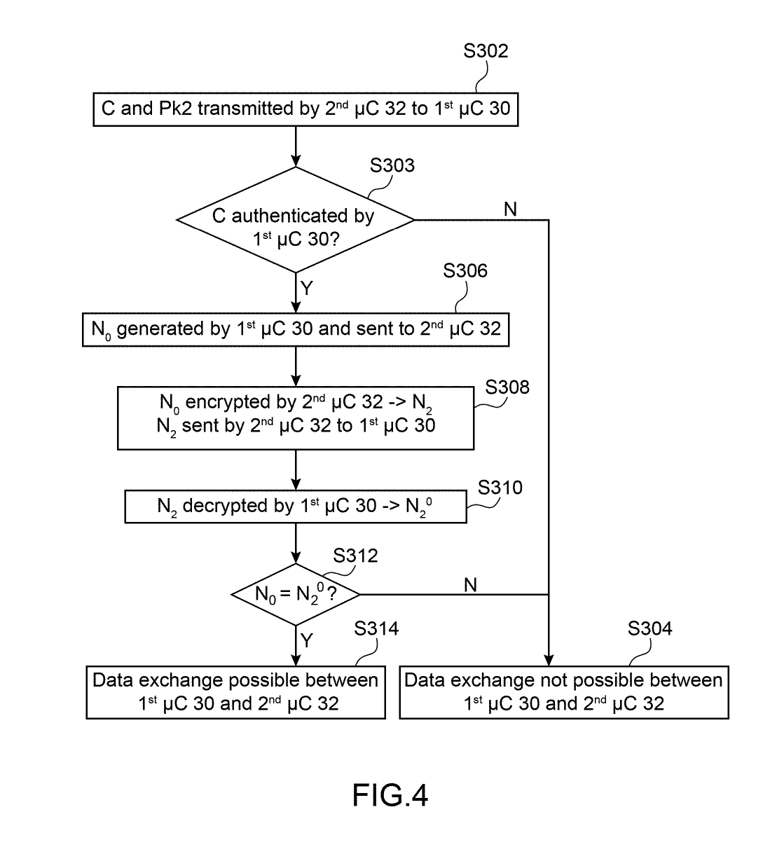

The invention can be used in a continuous inkjet (CIJ) printer like that described with reference to FIGS. 1 and 2. In particular, the printer comprises a print head 1, usually at a distance from the body of the printer 3, and connected to it by means, for example in the form of a flexible umbilical 2, assembling the hydraulic and electrical connections necessary for operation of the head.

The invention can advantageously be applied to a printer that is not connected to a communication network such as internet.

1. A method for an industrial printer to secure at least one consumable or detachable element, the printer comprising a 1^{st} microcontroller that is configured to make a data transfer with a 2^{nd} microcontroller of the printer or the consumable or detachable element, this method including at least:
a) an authentication of the 2^{nd} microcontroller by the 1^{st} microcontroller, then
b) one of the microcontrollers sends at least one data transfer secret key Sk1 to the other microcontroller, for transfers between the two microcontrollers, then
c) a data exchange between the two microcontrollers by symmetric encryption using the first data transfer secret key Sk1.

2. The method according to claim 1, in which step a) comprises at least the following steps:
send an electronic certificate C and a public key Pk2 generated from said electronic certificate C, from the 2^{nd} microcontroller to the 1^{st} microcontroller,
use the public key Pk2 to decrypt a signature contained in the electronic certificate C and encrypted by a private key Sk2 memorised in the 2^{nd} microcontroller,
generate a first random data N₀ by the 1^{st} microcontroller and send the first random data N₀ to the 2^{nd} microcontroller,
the 2^{nd} microcontroller encrypts the first random data N₀ using the private key Sk2 memorised in the 2^{nd} microcontroller, and the first encrypted random data N₂ is sent to the 1^{st} microcontroller,
the 1^{st} microcontroller decrypts the first encrypted random data N₂ using the public key Pk2, and the decrypted data N₂⁰ is compared with the first random data N₀ generated by the 1^{st} microcontroller.

3. The method according to claim 1, in which, when the 2^{nd} microcontroller is separated from the consumable or detachable element, step c) includes sending a secret authentication key K_AUTH from the 1^{st} microcontroller to the 2^{nd} microcontroller, between the 2^{nd} microcontroller and the consumable or detachable element.

4. The method according to claim 3, also including mutual authentication of the 2^{nd} microcontroller and the consumable or detachable element using the secret authentication key K_AUTH.

5. The method according to claim 1, also including a firmware authentication step of at least one of the microcontrollers, before step a).

6. The method according to claim 1, also comprising:
the 1^{st} microcontroller sends a write request and/or a read request to the 2^{nd} microcontroller, in a circuit of the consumable or detachable element;
an authentication by the 2^{nd} microcontroller, of data to be written sent by the 1^{st} microcontroller, and/or an authentication by the 1^{st} microcontroller of read data sent by the 2^{nd} microcontroller.

7. The method according to claim 1, the printer also comprising emitter/receiver for data exchanges with the consumable or detachable element, the authentication method also comprising an authentication of data exchange means by the 2^{nd} microcontroller.

8. The method according to claim 7, the emitter/receiver for data exchanges being of the RFID type, the consumable or detachable element also comprising RFID type emitter/receiver.

9. The method according to claim 1, in which said consumable or detachable element is an ink or solvent cartridge or a filter, or a pump or a solenoid valve or a removable module, for example a printer ink circuit or a printer print head, or a data support, or a computer code.

10. A control device of an industrial printer capable of checking the authenticity of at least one consumable or detachable element, comprising a 1^{st} microcontroller and a 2^{nd} microcontroller programmed to implement an authentication method according to claim 1.

11. An industrial printer comprising a control device according to claim 10.

12. A consumable or detachable element of an industrial printer, comprising means for implementing a method according to claim 1.

13. A consumable or detachable element of an industrial printer, comprising:
RFID type emitter/receiver,
means of sending data to an RFID reader of said printer, authenticated by said printer or to a microcontroller of said printer and authenticated by it, so as to authenticate the consumable or detachable element.

14. The consumable or detachable element according to claim 13, comprising means of receiving data from the RFID reader of said printer, authenticated by said printer or a microcontroller of said printer, authenticated by the printer, so as to authenticate the RFID reader or the microcontroller of said printer.

15. The consumable or detachable element according to claim 13, comprising means of receiving a second data transfer secret key K_TRF with the RFID reader or the microcontroller of said printer.
